(19) United States
(12) Patent Application Publication
(10) Pub. No.: US 2012/0244630 A1
(43) Pub. Date: Sep. 27, 2012

(54) MULTIPLEXED ANALYTE CONCENTRATION MEASUREMENT

(75) Inventors: Winnie Svendsen, Copenhagen S (DK); Martin Hedegard Sorensen, Copenhagen O (DK); Kristina Aggergaard Christiansen, Taastrup (DK); Pranjul Jaykumar Shah, Ahmedabad (IN)

(73) Assignee: Danmarks Tekniske Universitet, Kgs. Lyngby (DK)

(21) Appl. No.: 13/394,864

(22) PCT Filed: Sep. 6, 2010
(86) PCT No.: PCT/EP2010/063033

§ 371 Date: May 29, 2012

Related U.S. Application Data
(60) Provisional application No. 61/240,368, filed on Sep. 8, 2009.

(30) Foreign Application Priority Data
Sep. 8, 2009 (EP) 09169729.2

(51) Int. Cl. G01N 27/02

(52) U.S. Cl. 436/501; 422/69

(57) ABSTRACT

Disclosed is a method of multiplexed concentration measurement of one or more analytes in a sample by means of electrical impedance measurements, the method comprises the steps of : providing the sample; providing a plurality of subsets of particles with capture molecules specific for at least one of the analytes, where the particles in each subset are distinguishable from the particles in the other subsets; mixing the sample with the subsets of particles, wherein the method further comprises the steps of: measure the change in the electrical impedance measurement, when the particles pass one or more sets of electrodes; determining the concentration of the one or more analytes by analyzing the electrical measurement change associated with the particles passing by the electrodes, where the concentration of the one or more analytes are determined based on a change in a property of the respective particles.

The present invention generally relates to a method and a device for multiplexed analyte concentration measurement, in particular a method and a device for determining the concentration of analytes or target substances, such as proteins. More particularly, the invention relates to a method of determining the concentration of one or more analytes in a sample by means of electrical impedance measurements.

### BACKGROUND

Immunoassays represent a predominant form of analysis in the modern-day clinical analysis repertoire. Immunoassays are quantitative analysis based on utilizing the binding properties of an antibody to a specific antigen in a sample. This interaction between antibody and antigen is converted into a measureable signal that can be related to the concentration of a specific protein.

Current state of the art within Immunoassays is Enzyme Linked Immuno Sorbent Assay (ELISA). ELISA converts the concentration of a specific protein into a measurable signal by an antibody-bound enzyme converting a non-coloured substance into a coloured substance. The colour intensity of this substance is measured with a spectrometer and corresponds to a certain concentration of a specific protein. The ELISA method involves multiple reaction steps all using different reagents resulting in an overall measurement time between 4-6 hours. ELISA is considered to be both a slow and labour intensive method requiring multiple reagents and a bulky spectrometer. Often ELISA testing is highly automated, lowering operational costs. However the measurement time cannot be reduced because of the binding events required between each step in the process, and even though it is highly automated, it still requires a significant amount of manual work from the lab-technician both post and pre the analysis. These automated machines also have problems with false positives due to a lack of specificity.

The article □Bead-based immunoassays using a micro-chip flow cytometer□ by Holmes et al. from The Royal Society of Chemistry 2007 journal discloses a microfabricated flow cytometer developed for the analysis of micron-sized polymer beads onto which fluorescently labelled proteins have been immobilised. Fluorescence measurements were made on the beads as they flowed through the chip. Binding of antibodies to surface-immobilised antigens was quantitatively assayed using the device. Particles were focused through a detection zone in the centre of the flow channel using negative dielectrophoresis. Impedance measurements of the particles (at 703 kHz) were used to determine particle size and to trigger capture of the fluorescence signal. Antibody binding was measured by fluorescence at single and dual excitation wavelengths (532 nm and 633 nm). Fluorescence compensation techniques were implemented to correct for spectral overspill between optical detection channels. The data from the microfabricated flow cytometer was shown to be comparable to that of a commercial flow cytometer (BD-FACSAria).

The article □Challenges of Electrochemical Impedance Spectroscopy in Protein Biosensing□by A. Bogomolova et al. from Anal. Chem., Publication Date (Web): 13 Apr. 2009 discloses electrochemical impedance spectroscopy (EIS) measurement, performed in the presence of a redox agent, which is a convenient method to measure molecular interactions of electrochemically inactive compounds taking place on the electrode surface. High sensitivity of the method, being highly advantageous, can also be associated with nonspecific impedance changes that could be easily mistaken for specific interactions. Therefore, it is necessary to be aware of all possible causes and perform parallel control experiments to rule them out. The results obtained during the early stages of aptamer-based sensor development is presented, utilizing a model system of human alpha thrombin interacting with a thiolated DNA aptamer, immobilized on gold electrodes. EIS measurements took place in the presence of iron ferrocyanides. In addition to known method limitations, that is, inability to discriminate between specific and nonspecific binding (both causing impedance increase), other factors leading to nonspecific impedance changes are found, such as: (i) initial electrode contamination; (ii) repetitive measurements; (iii) additional cyclic voltammetry (CV) or differential pulse voltammetry (DPV) measurements; and (iv) additional incubations in the buffer between measurements, which have never been discussed before.

US 2003/0119057 discloses engineered microparticles, libraries of microparticles, and methods relating thereto. The microparticles are distinguishable based on differences in dielectric response to an applied electric field. In different embodiments, the dielectric differences may be engineered through, but not limited to, dielectrically dispersive materials, surface charge, and/or fluorescence. Gangliosides may be incorporated with the microparticles to control aggregation. Vesicles including erythrocyte ghosts may be used as a basis for microparticles. The microparticles may utilize a biotin streptavidin system for surface functionalization.

U.S. Pat. No, 6,551,788 discloses methods of assaying one or more analytes simultaneously. The assays of this invention are capable of providing wide dynamic range and rapid processing times. A wide dynamic working range is achieved by simultaneously incubating a sample which may contain the analyte(s) of interest with two or more independently determinable classes of particles coated with an analyte-specific binding partner. The two or more particle classes differ from each other at least in size. The analyte concentration is obtained from readings derived from these two classes by means of a combined standard curve.

EP 0 413 741 discloses a method of assay of one or more analytes in an aqueous sample wherein for each analyte to be assayed monodisperse particles carrying a specific binding partner for that analyte are used to bind the said analyte in the sample and a labelled ligand is used to indicate the amount of said bound analyte, the amount of labelled ligand bound to the particles being determined by a flow cytometer, characterised in that for each analyte to be assayed a pair of different particle types is used, the particles of each of the two particle types of said pair carrying a binding partner having the same specificity but having a different binding affinity for the said analyte, the pair of particle types which has reacted with each analyte to be assayed and become labelled by a labelled ligand being distinguishable by the flow cytometer from each other and from the pairs of particle types which have reacted with each other analyte to be assayed. A corresponding kit for carrying out the method is also provided.

The presence of multiple steps and reagents as well as external bulky equipment render devices and methods of prior art expensive and possibly complicated to use.

In a wide variety of diagnostic applications it is desirable to perform measurements, where the results are provided quickly, and where the results are provided directly and therefore are simple to read out, and where the method and/or device may be operated without specific technical skills. In some applications the sample volume and the specificity of the antigen-antibody binding may also be a problem.

Thus it remains a problem to provide an improved method that preferably alleviates, mitigates or eliminates one or more disadvantages of the prior art, singly or in any combination, in particular for measuring the concentration of several different analytes or target substances in the same sample.

### SUMMARY

Disclosed is a method of multiplexed concentration measurement of a plurality of analytes in a sample by means of electrical impedance measurements. The method comprises providing the sample comprising the plurality of analytes; providing a plurality of particle subsets, where the particles in each subset comprise a number of capture molecules specific for at least one of the analytes, and where the particles in each subset are distinguishable from the particles in the other subsets; and mixing the sample comprising the plurality of analytes with the one or more subsets of particles, whereby the plurality of analytes are enabled to bind to the respective capture molecules. The method may further comprise measuring the electrical impedance between electrodes, when the particles pass one or more sets of electrodes; and determining the concentrations of the plurality of analytes by analyzing the electrical impedance associated with the particles passing by the electrodes. The concentrations of the plurality of analytes may be determined based on a change in a property of the respective particles.

The electrical impedance measurements are used for determining properties of the respective particles, e.g. beads with or without attached analyte. Determination of change in properties, e.g. size, of the respective particles allows calculation of analyte particles in the sample.

Also disclosed is a method of multiplexed concentration measurement of one or more analytes in a sample by means of electrical measurements, the method comprises the steps of providing the sample comprising the one or more analytes; providing one or more subsets of particles, where the particles in each subset comprise a number of capture molecules specific for at least one of the analytes, and where the particles in each subset are distinguishable from the particles in the other subsets; and mixing the sample comprising the one or more analytes with the one or more subsets of particles, whereby the one or more analytes are enabled to bind to the respective capture molecules. The method may further comprise measuring the change in the electrical measurement, when the particles pass one or more sets of electrodes; and determining the concentration of the one or more analytes by analyzing the electrical measurement change associated with the particles passing by the electrodes, where the concentration of the one or more analytes are determined based on a change in a property of the respective particles.

Consequently, it is an advantage that the concentration of each type of several different analytes or target substances, such as for example proteins, can be measured in one experiment. Furthermore, the measurement time can be reduced from hours as in the traditional tests to minutes, and it is thus an advantage that the measurement can be performed fast, and the result of a test can thus be delivered in a short time due to the reduced amount of binding events required per test.

This furthermore leads to a faster turn-around-time (TAT), and to reduced variable costs as fewer labour hours and reagents are needed. The required sample size may also be smaller, and the use of a spectrometer can be avoided. Thus the test may be easy to perform, and a trained technician may not be required for performing the test.

Furthermore, according to the present method no labeling of the analytes and no excitation of fluorescent substances are required, and the present method therefore comprises fewer steps than prior art methods.

However, the multiplexing part of this method can be used in combination with other methods to multiplex these methods.

In general, the electrical impedance measurements of the present method may be combined with other methods.

The method may be used where e.g. a blood sample is taken from a patient suffering from e.g. chest pain in order to perform e.g. a Myocardial infarction or thrombosis diagnosis and the blood is then mixed with the particles covered with antibodies. A protein in the blood, e.g. Myoglobin, will bind specifically to a particle covered with a corresponding antibody towards this protein. Thus the method enables detection of antibody-antigen binding, such as antibody-target protein binding. These particles coated with antibodies have a specific impedance value or signal which is pre-calibrated, and when the test is performed, these specific impedance values or signals are used for performing the measurement of the concentration of the analyte type.

Thus the present method is based on the antibody-antigen interaction like ELISA. However the method does not need multiple reactions steps to convert this binding into a measurable signal. The method exploits that the antibody-antigen interaction can be converted into a detectable electrical signal, revealing the concentration of a specific protein in a sample. Furthermore the method makes it possible to simultaneously measure the concentration of multiple proteins in a sample, which is not possible with ELISA. The method can be capable of measuring e.g. ten or more different protein concentrations simultaneously and deliver the result within minutes.

The conventional automated machines used in combination with ELISA have problems with false positives due to lack of specificity. It is an advantage that by using the present method this problem can be solved by using e.g. 10 antibodies with different specificities towards one protein in one sample. Furthermore, it is an advantage of the present method that the sample volume can be reduced by performing the entire test in one single run

The device containing the technology to perform the present method may consist of an analyzer measuring the electrical signal and displaying the different protein concentrations, and a small disposable chip or microchip, e.g. of the size 18 mm×28 mm, comprising the particles such as beads. The microchip can be replaced after each measurement, while the analyzer may be permanent and reusable. The chip device may be integrated into an existing product series since the work routines are similar to those of ELISA. This integration may be easily performed by lab-technicians. Furthermore, the present method and device can easily be scaled and automated like the current ELISA technology to match any size and volume preference of hospitals and laboratories. Thus the advantages are still faster turn-around-time (TAT), reduced variable cost per test, and slightly lower investment costs. It is also possible to upscale the method by having several arrays on a single chip where each array may detect and/or measure ten or more different analyte concentrations.

For example in order to test for Myocardial infarction, a number of protein concentrations must be measured, and thus by means of the present method, the diagnose can be determined much faster and easier than by using ELISA, since in the present method the proteins are measured directly and immediately without having to wait for further binding steps, fluorescence measurements, using labelling etc.

Thus, it is an advantage that a simple, cheap, and fast method is provided, e.g. since it may help to quickly diagnose a disease, implement proper treatment and prevent the spread of a disease from healthy carriers, both in hospitals and in the community. Therefore, improving the quality of treatment decisions can result in significant economic benefits. In some cases a fast diagnosis may even save lives by leading to a faster treatment.

The change in the electrical measurement, such as for example change in electrical impedance, depends on the analyte, e.g. protein, concentration bound to the particle, e.g. bead, and on the particle size and/or particle material. If the particles are made of different material and/or have different size, then signals obtained from different particles can be isolated. This multiplexed signal will provide detection of several different protein concentrations in one experiment.

The method may be performed in a micro fluidic chamber, in micro fluidic channels and/or in a flow chamber, and by means of controlling the flow in the chamber or channels it may be ensured that only one particle will pass the electrodes at a time, and thus each single electrical measurement, e.g. impedance measurement, relates to only one particle. When the particles have passed the electrodes, the output provides information of the concentration of each of the tested analytes, e.g. proteins. The output is the electrical signals, e.g. impedance measurement signals, where each type of particle gives a certain impedance value for example, and each type of particle with protein attached gives another impedance value, depending on the amount of protein attached, which is associated with the concentration of the specific protein in the sample.

There may be used any suitable number of the same type of particle in a test. And there may be used any suitable number of different particles in a test.

An alternative example of the method may be that a cell, i.e. the analyte, expressing cancer markers on its surface is mixed with particles covered with antibodies towards the cancer markers. The antibody covered particles will bind to the cancer markers on the cell. The number of bound particles can be measured using impedance, and the number of bound particles will correspond to the amount of cancer markers present on the cell surface. Thus the amount or concentration of cancer markers is measured. This concentration can then be used to determine the cancerous state of cell.

In an alternative example, one could detect small clumps of the particles instead of only one particle at a time.

Before performing the method, a medical staff person may choose which particle types that should be used in the experiment. The choice of particles is based on which analytes, e.g. proteins, there should be tested for. If there is a presumption that a patient suffers from disease X, the medical staff persons knows or looks up in a database or register that disease X will or can cause that both protein A and protein B are present in large concentrations in the patient□s blood, and thus the medical staff person chooses to use at least a particle with a capture molecule to which protein A binds specifically, and another particle with another capture molecule to which protein B binds specifically.

If there is a need for testing for more than e.g. five to ten different proteins in a blood sample, the experiment could be performed more than one time, and different particles can be used in the experiments. However, the present technology can be put in an array format on a chip to increase the number of tests per cycle or chip. The change in the processing routine will be the need of more samples, i.e. one sample volume per test. A negative or positive control could also be included on the chip.

The method may be used for detecting and determining the concentration, i.e. the amount, of analytes like proteins, bacteria, molecules, vira, cells, disease markers, DNA, chemical compounds and nanosized or microsized analytes in general. In all cases, the analytes and the particles bind together. In some cases the analytes bind specifically to a capture molecule on a particle.

Depending on how much of each type of analyte, e.g. protein, that is present in the sample, e.g. blood sample, some amount of, or maybe even no, protein attaches to the respective particles, e.g. beads, and if only little of protein X is present in the blood, i.e. low concentration of protein X, only little protein X will attach to the respective beads and thus only a little impedance difference is found between the bead with no protein attached and the bead with little protein attached, and thus the impedance measurement will only show a little concentration of protein X. Whereas if a large amount of protein X is present in the blood, i.e. high concentration of protein X, a large amount of protein X will attach to the respective beads and thus a high impedance difference is found between the bead with no protein attached and the bead with a large amount of protein attached, and thus the impedance measurement will show a high concentration of protein X.

The particles in each subset comprises a number of capture molecules specific for at least one of the analytes, which means that the particles may be covered or functionalized with the capture molecules, and/or that capture molecules are immobilized on the particles or the surface of the particle itself act as a capture molecule.

A capture molecule may be a molecular layer, biological layer, non-biological layer, chemical layer, metal layer, particle layer etc. A biological layer may e.g. be a nucleic acid, a receptor, an enzyme, an antibody or an antibody-like molecule, a protein, amino acids etc. A metal layer may more specifically be a layer of Au, Ag, Pt, Pd, Al, Cu. A particle layer may consist of metal nano-particles.

A molecular layer may more specifically be a layer of receptor molecules, capable of selectively binding specific molecules, such as macro-molecules, bio-molecules, DNA, such as single- or double-stranded DNA, e.g. from disease associated genes, DNA-like molecules, RNA, antigens, antibodies, nucleic acids, amino acids, cells, such as cardiac cells, bacteria, vira, fungi, various drug molecules, traces of toxins etc.

The molecular layer may e.g. change the physical properties of the bead surface. The layer could for instance make the surface hydrophobic or make the surface electrically charged.

The molecular layer may consist of a combination of the above mentioned or other layers and/or substances.

The electrodes are the connections from an electrical circuitry to an object, such as a particle, to be acted upon by the electrical current.

The distances between the electrodes may for example be 10-50 m, such as 10 m, or 20 m.

It is understood that the electrode material may be metal or an electrical conducting material integrated in the chip, e.g. a conducting polymer. More than two electrodes may be used for performing the same measurement several times to verify the result.

The method may be used for single tests, or the method may be used for continuous measurements, whereby particles mixed with analytes constantly and continuously passes by the electrodes for measuring the concentration of one or more of the analytes. If continuous measurements are performed, the large amount of data resulting from the ongoing measurements may be processed by means of chemometrics.

In a test, for example using a sample of a patient□s saliva, urine, blood or other bodily by-products, the sample and the particles, e.g. beads, can be mixed and then passing the electrodes for example in micro fluidic channels or in a flow chamber in the chip. Alternatively, the sample and the beads can be mixed, and after the analytes, e.g. proteins, from the sample have had time to bind to the beads, the beads are extracted from the sample. The beads are then mixed with a fluid, such as water or a buffer solution, and then the fluid and the beads are sent to pass the electrodes in the chip. Alternatively, the proteins from the sample are extracted and then mixed with the beads in a fluid solution, and then sent to pass the electrodes.

Reagents may be mixed with or added to the beads, for example to further modify the beads. The reagents may be added before the analyte/sample is mixed with the beads. The reagents may be added in channels in the micro fluidic chip. Thus the mixing of reagents and beads may be performed in channels which are arranged prior to the channels where beads and analytes are mixed.

Multiplexed concentration measurement is defined as simultaneous measurement of concentration of multiple analytes in a single test, i.e. measurement of at least a first analyte concentration of a first analyte and a second analyte concentration of a second analyte.

In some embodiments the change in the property of a particle is at least the thickness of the layer of the attached analytes on the particle.

In some embodiments the change in the property of a particle is at least the weight of the attached analytes on the particle.

In some embodiments the change in the property of a particle is at least the electrical charge of the attached analytes on the particle.

In some embodiments the electrical measurement is of electrical impedance.

Thus the measurement may be electrical impedance spectroscopy. Alternatively, the electrical measurement may be a measurement of electrical conductance. Alternatively or in combination, the electrical measurement may be an electromagnetic measurement.

In some embodiments the particles are beads. The beads may be made of polystyrene, latex, rubber, plastics, glass etc. The beads may comprise different layers made of different material and having different electromagnetic properties, such as conducting or insulating. A bead can for example consist of polystyrene with a core of iron-oxide that can be magnetized. The bead types differ by size and/or material. If five-ten different bead sizes are used in one experiment, this means that there can be tested for the presence of five-ten different analytes, e.g. proteins, in one experiment, and the concentration of each of the present proteins is outputted.

The sizes and/or materials of different beads are selected such that even if a lot of protein or analyte, e.g. in case of high protein concentration, binds to one bead type, the impedance signal obtained from this bead type can still be differentiated from the impedance signal obtained from a different bead type, e.g. a larger bead type, having no or only a small amount of protein or analyte attached, e.g. a low protein concentration.

The beads may have a size which is down to 10 nm in diameter or smaller.

Alternative and/or additionally, the beads may have diameters from 1-1,000 micrometer, and the layer-thickness of attached analyte on a bead may typically be about 10 nm thick. So for example if five different beads are used, having diameters of one micrometer, three micrometer, five micrometer, seven micrometer and nine micrometer, respectively, it may be easy to differentiate the impedance signals between the different beads types, both with and without analyte attached.

Alternatively, the particles may be cells, bacteria, molecules etc., i.e. anything with which an analyte can bind.

In some embodiments the particles are adapted to exhibit magnetic properties.

There may be a permanent magnet integrated in the particles, or the particles may be magnetizable e.g. the particles may comprise a material, which can be magnetized, e.g. iron oxide.

In some embodiments the analytes are proteins.

The proteins may be heart markers, i.e. markers for heart diseases, such as e.g. Troponin, Myoglobin CKMB, Myoglobin, NT-proBNP, CRP, βhCG, D-dimer etc.

Alternatively, the analytes may be alcohols, microorganisms, pesticides, cells, vira, bacteria, fungi, glucose, enzymes, DNA, e.g. DNA in metaphase where the DNA molecule is circular, etc.

In some embodiments the capture molecules are reactive layers.

In some embodiments the capture molecules are antibodies.

The present invention relates to different aspects including the method described above and in the following, and corresponding methods, devices, uses and/or product means, each yielding one or more of the benefits and advantages described in connection with the first mentioned aspect, and each having one or more embodiments corresponding to the embodiments described in connection with the first mentioned aspect and/or disclosed in the appended claims.

In particular, disclosed herein is a device for multiplexed concentration measurement of a plurality of analytes in a sample by means of electrical impedance measurements, the device comprising:
a chip with micro fluidic channels, where the micro fluidic channels comprise a first part of a channel adapted for mixing the sample comprising the plurality of analytes with one or more subsets of particles, where the particles in each subset comprises a number of capture molecules specific for at least one of the analytes, whereby the one or more analytes are enabled to bind to the respective capture molecules, and where the particles in each subset are distinguishable from the particles in the other subsets,
at least two electrodes in a second part of the channel for performing the electrical measurements, when the particles pass the electrodes;

where the change in the electrical impedance measurement is calculated by a processor, when a particle passes the electrodes and, based on this, the concentrations of the plurality of analytes is determined by analyzing the electrical impedance measurement change associated with the particles passing by the electrodes, where the concentrations of the plurality of analytes are determined based on a change in a property of the respective particles.

An advantage of the device is that the micro fluidic chamber or channels may be used for fluidics, i.e. liquids or gasses. An example of using the micro fluidic chamber for liquids is using a sample of blood, saliva, urine or water, with proteins. An example of using the micro fluidic chamber for gasses is an airborne virus to be detected and concentration determined by means of the device.

The device may comprise more than one channel with electrodes for measuring the impedance of the passing beads, e.g. one channel for each bead size, then the measurement of all the beads and proteins may be performed faster.

The micro fluidic channels of the device may comprise focusing means, such as focusing channels, for ensuring that the particles passes through the channel one-by-one, so that an impedance measurement only relates to one particle and not to more. The focusing means may comprise hydrodynamic focusing, hydrodynamic filtration etc.

The device may comprise mixers or mixer-elements in the channel(s) for ensuring a good mixing of the particles and the sample containing analytes The device may also include mixing of particles and capture molecules.

For ensuring that the fluidic passes through the channels in the device, in-going or out-going pressure can be applied to the micro fluidic channels, e.g. actuation of liquid flow may be implemented by external pressure sources, external mechanical pumps, integrated mechanical micropumps, or by electrokinetic mechanisms.

The micro fluidic chamber, channels and/or electrodes may be constructed so as to provide a large physical covering or framing of the particles for obtaining the best possible measurements.

In some embodiments of the device, the channels are treated on the internal side to prevent that analytes adhere inside the channels.

The treatment may be such as a coating with a chemical agent or a physical change such as changing the electric charge of the inside of the channel, such as change in the surface properties.

Alternatively and/or additionally, the treatment may comprise blocking by means of a protein, such as bovine serum albumin (BSA) and/or the like.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1 shows a schematic example of a measurement by means of the present method,

FIG. 2 shows schematic examples of particles etc., which can be used in different applications of the method,

FIG. 3 shows a schematic example of measurement of particles with attached analytes,

FIG. 4 shows the binding steps in the present method and in prior art method,

FIG. 5 shows an example of a micro fluidic chip used for performing the present method,

FIG. 6 shows examples of embodiments of the micro fluidic channels on the chip,

FIG. 7 shows an example of the composition or construction of the chip with micro fluidic channels,

FIG. 8 shows an example of the electric circuit used to perform the electrical measurement, and

FIG. 9 shows an example of a flow diagram of the present method.

### DETAILED DESCRIPTION

In the following description, reference is made to the accompanying figures, which show by way of illustration how the invention may be practiced.

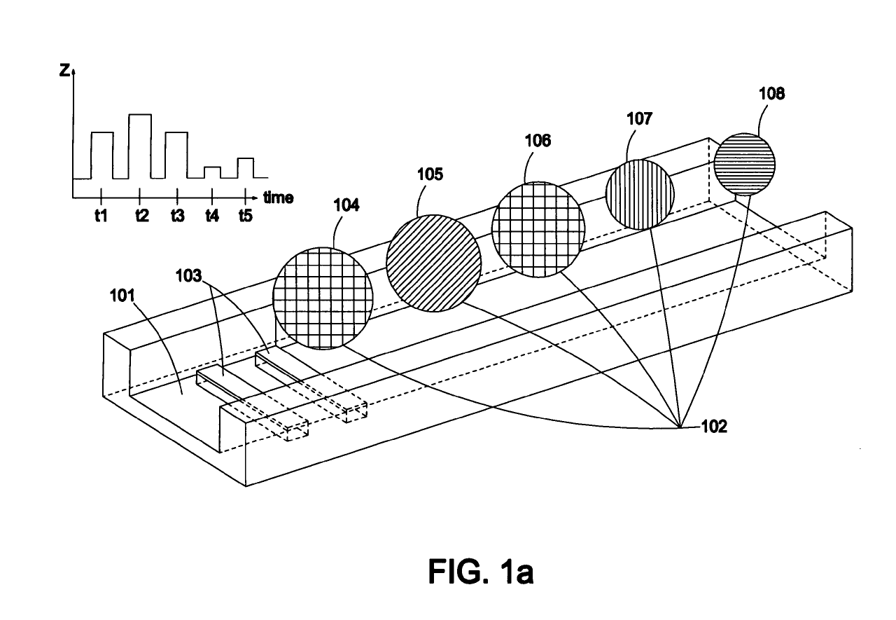

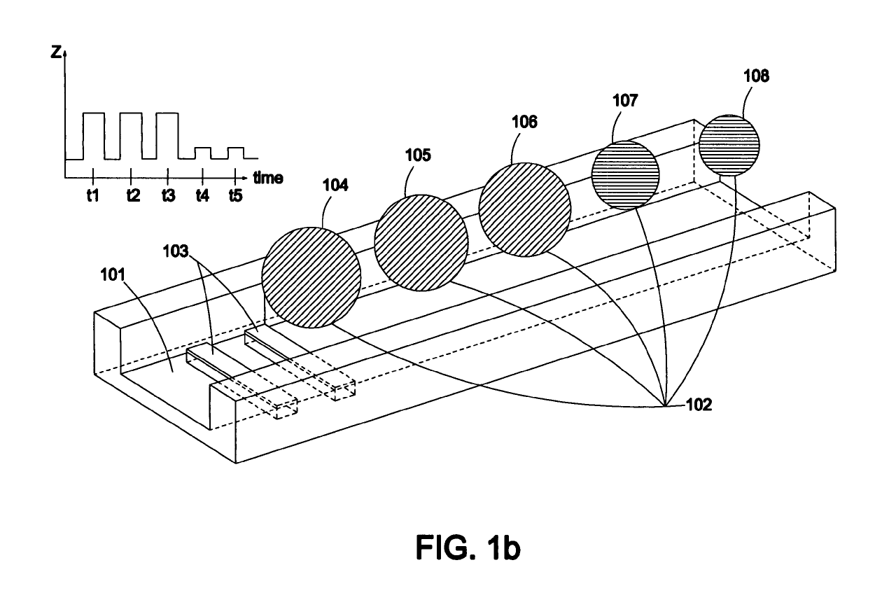

FIG. 1 shows a schematic example of a measurement.

FIG. 1a) shows a fluid channel 101 in which the particles 102, called beads 102 in the following, passes through. When a bead 102 passes the electrodes 103, the impedance is measured. Only one bead 102 is shown to pass the electrodes 103 at a time, so that it is ensured that one impedance measurement only measures the impedance of one bead and not of more beads.

In the top left corner of the FIG. 1a), a graph is shown which shows the change in impedance, Z, over time, as the beads 102 pass the electrodes 103. At time t1, bead 104 passes the electrodes; at time t2 bead 105 passes the electrodes; at time t3 bead 106 passes the electrodes; at time t4 bead 107 passes the electrodes; and at time t5 bead 108 passes the electrodes. Beads 104, 105 and 106 are of the same bead size, but only bead 105 is shown to have analytes or target substances, called proteins in the following, attached. Thus the impedance value Z is seen to be larger at time t2, where bead 105 with the attached protein passes the electrodes, than at time t1 where bead 104 without attached protein passes the electrodes or at time t3 where bead 106 without attached protein passes the electrodes. However, the impedance value may also be smaller, when proteins are attached.

Bead 107 and 108 are of the same bead type, where type indicates size and/or material, but only bead 108 is shown to have protein attached. Thus the impedance value Z is seen to be larger at time t5, where bead 108 with the attached protein passes the electrodes, than at time t4 where bead 107 without attached protein passes the electrodes. Again, the impedance value may also be smaller, when proteins are attached.

Thus by means of the impedance value Z it is possible to distinguish between the same bead type and/or bead size with and without attached protein.

Thus FIG. 1a) may illustrate how to calibrate the impedance measurements, since the impedance of the same bead type/size with and without protein is measured.

FIG. 1b) shows an example of an actual test of protein concentrations.

In the top left corner of the FIG. 1b), a graph is again shown which shows the change in impedance, Z, over time, as the beads 102 pass the electrodes 103. At time t1, bead 104 passes the electrodes; at time t2 bead 105 passes the electrodes; at time t3 bead 106 passes the electrodes; at time t4 bead 107 passes the electrodes; and at time t5 bead 108 passes the electrodes. The impedance values Z at both time t1, t2 and t3 are the same as the high impedance value at time t2 in FIG. 1a), and thus bead 104, 105 and 106 all have the same amount of protein attached, and thus the protein concentration of the specific protein which binds to bead type 104, 105, 106, is the same as seen for bead 105 in FIG. 1a).

Similarly, the impedance values Z at time t4 and t5 are the same impedance value as the value at t5 in FIG. 1a), and thus bead 107 and 108 both have the same amount of protein attached, and thus the protein concentration of the specific protein which binds to bead type 107 and 108 is the same as seen for bead 108 in FIG. 1a).

The dimensions in FIG. 1 are not drawn to scale.

Thus different impedance values correspond to different beads with different amounts of analyte, e.g. protein, attached, and thus corresponds to different concentrations of proteins in the sample. For example, the amount of analyte, e.g. protein, bound to a number of beads of similar size can be compared with a chart where The amount of analyte binding to individual beads is correlated to the known concentration of the analyte in the solution□ Hence for an unknown analyte (protein) it is possible to identify the average number of analytes bound to all the beads of same sizes, the calibration chart enables determination of the concentration of the respective analyte in the solution/sample.

The impedance values may depend on the type of particle, i.e. size and/or material, the attached analyte/protein, the electrode distance, the fluid or liquid or solution which the particles and analytes are in, and so on.

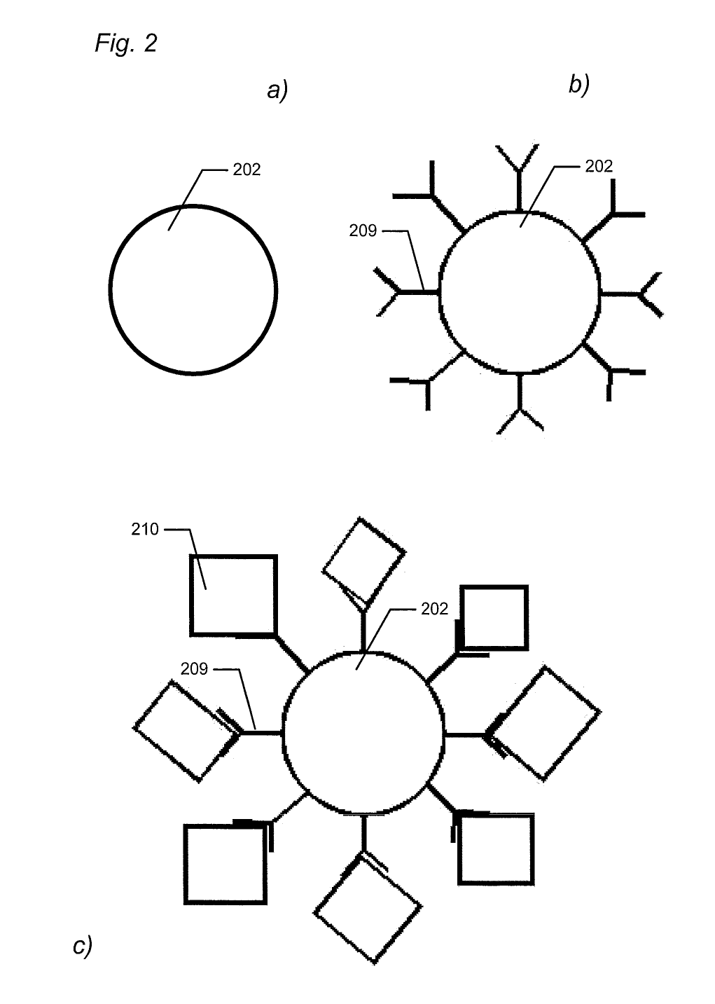

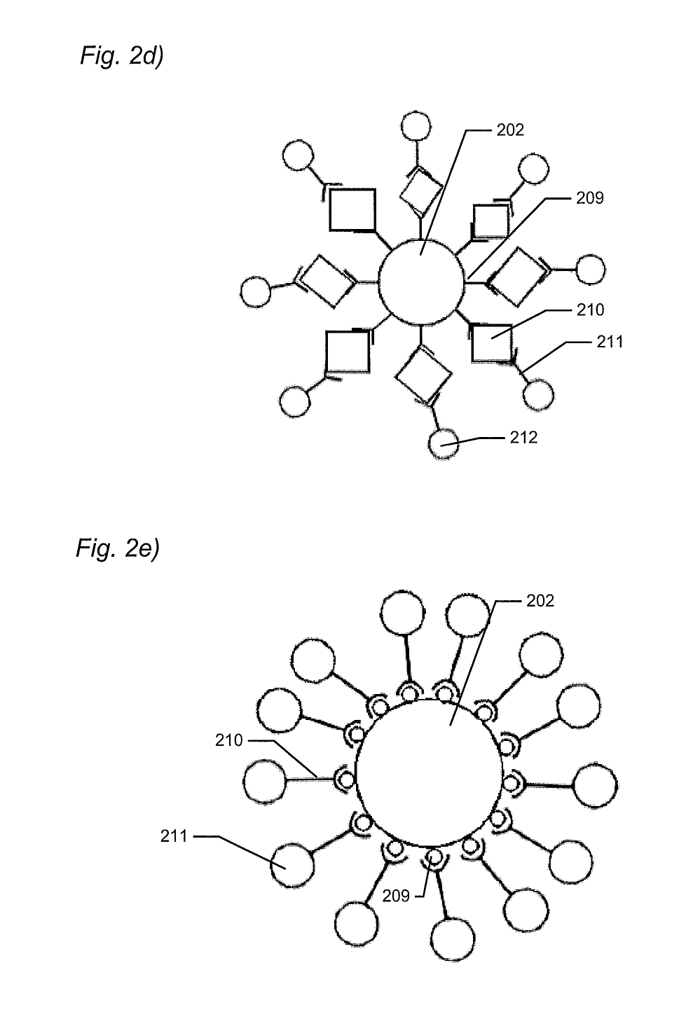

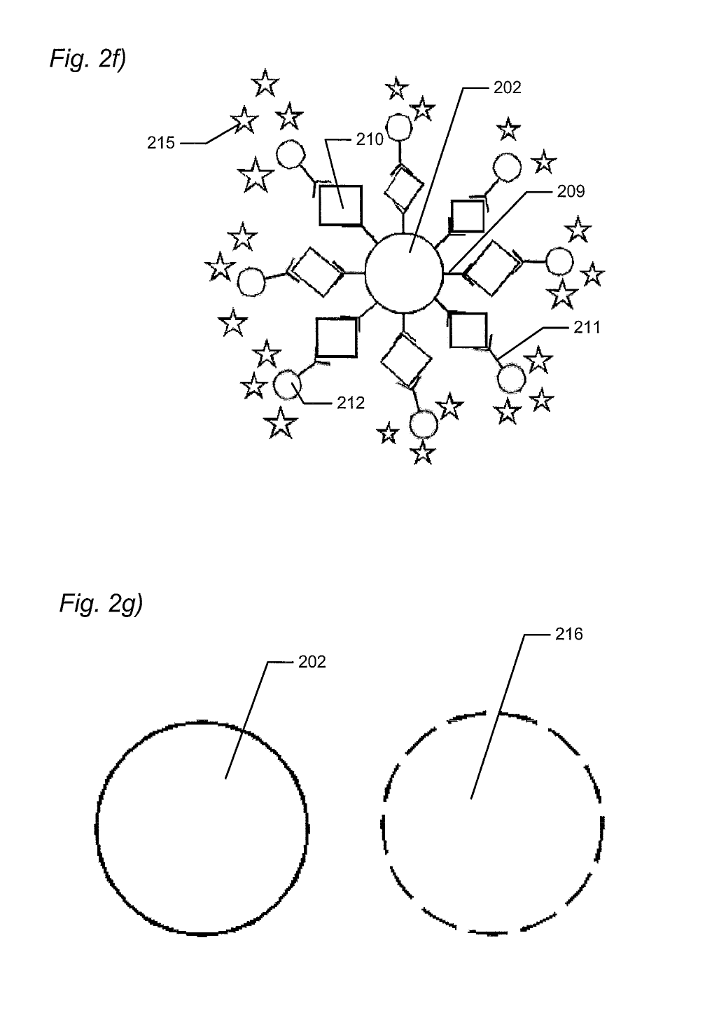

FIG. 2 shows schematic examples of the particles etc. which can be used in different applications of the method.

FIGS. 2a)-2c) show an example with a particle, capture molecules such as an antibodies, and analytes. FIG. 2a) shows a particle 202, called bead 202 in the following. FIG. 2b) shows a bead 202 with eight capture molecules 209, called antibodies 209 in the following. FIG. 2c) shows a bead 202 with eight antibodies 209 and with analyte 210, called protein 210 in the following, attached to each of the antibodies 209. Thus before beads 202 and e.g. a blood sample containing protein 210 are mixed in order to measure the protein concentration of the protein 210, antibodies 209 are attached to the beads 202, so that proteins 210 can attach to the beads and impedance can be measured.

FIG. 2d) shows an example with a larger bead with smaller beads attached. The large bead 202 has eight antibodies 209 attached, and at each antibody 209 an analyte 210 is bound. Furthermore, on each of the analytes 210 another antibody 211 is attached and on each of these antibodies 211 a smaller bead 212 is attached.

FIG. 2e) shows an example with a cell with proteins and smaller beads attached. The particle is a cell in this example, and the cell 202 has a number of capture molecules 209 attached on its surface, and the capture molecules are proteins 209, and at each protein 209 another capture molecule 210 is attached, and these capture molecules are antibodies 210, and at each antibody 210 a smaller bead 211 is attached.

FIG. 2f) shows an example where fluorescence is used. FIG. 2f) shows a large bead 202 which has eight antibodies 209 attached, and at each antibody 209 an analyte 210 is bound. Furthermore, on each of the analytes 210 another antibody 211 is attached and on each of these antibodies 211 a smaller bead 212 is attached. When fluorescent molecules, e.g. the smaller beads 212, are excited by means of radiation or light with a certain wavelength, fluorescent light 215 is emitted, and from the fluorescence it can be determined what the concentration of the target substance, e.g. the analytes 210, is.

As an example, beads coated with antibody can be provided in a channel, where the sample with analytes is mixed with the beads, and this may result in that beads clump together in small clusters. The size and number of the clusters are used to perform detection of analytes and/or determine the concentration of the analytes.

FIG. 2g) shows an example of a normal healthy cell 202 and an infected cell 216 where the surface or physical properties of the cell are changed.

A cell infected with for example a virus or a phage will have different physical properties than a cell which is not infected, and these changes in the physical properties can also be detected with the present method. The change in the physical properties of an infected cell is due to the partial breakage of the cell membrane caused by the virus infection. The impedance signal from a cell will depend on the state of the cell, and the presence and/or concentration of infected cells can be determined by using the present method.

Thus it can be determined whether a type of cell is infected or not infected according to the present method. Thus an infected or not infected cell can be distinguished. The change in impedance of cells of the same type can also be due to over-expression of a protein e.g. a receptor, such as a cancer cell.

An application for the above can be to place a device in a fermentor or bioreactor which for example produces some kind of food ingredients, e.g. a flavor, some kind of milk product, etc. The device makes it possible to monitor the production continuously by checking if the cells in the fermentor are infected by virus, and/or measuring various analyte concentrations.

A way to prepare a sample for measurement may be included in the device, for example lysis of cells to perform protein concentration measurements on proteins within a cell.

The device may be handheld or portable, such that veterinarians can bring it to e.g. pig or chicken farms for on-sight testing of different kinds of deceases.

The dimensions in FIG. 2 are not drawn to scale.

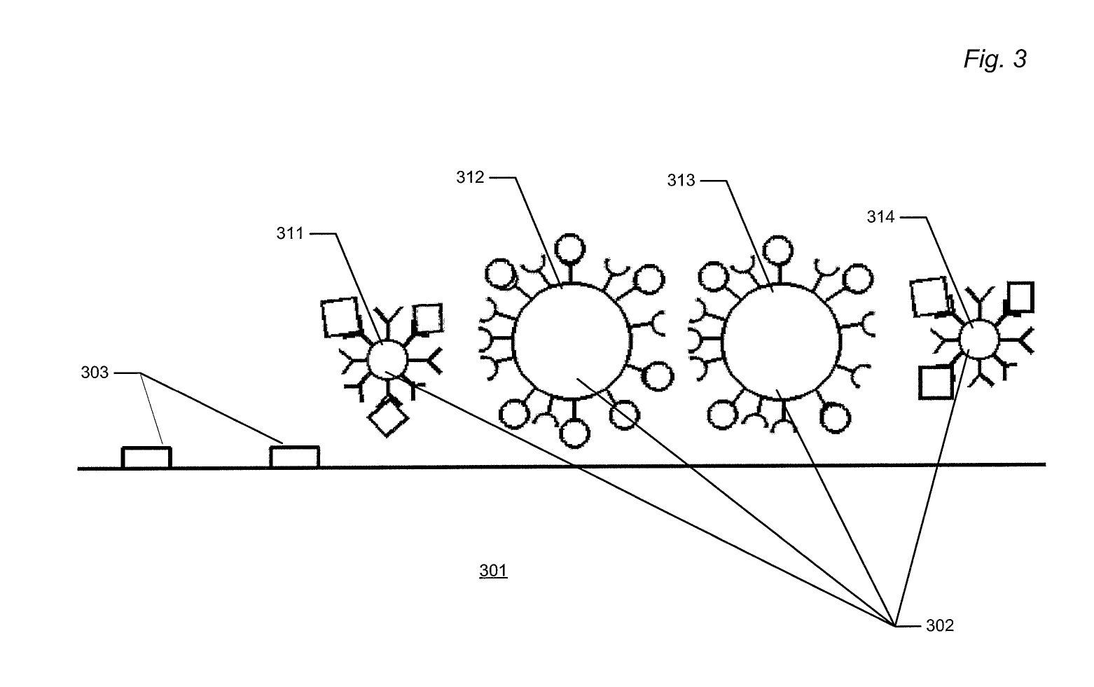

FIG. 3 shows a schematic example of measurement of particles with attached analyte.

The figure shows a fluid channel 301 in which the particles 302, denoted beads 302 in the following, pass through. When a bead 302 passes the electrodes 303, the impedance changes and, the impedance change is observed and/or registered by the system.

Bead 311 is shown to have eight antibody molecules and at three of these antibodies proteins are attached. Bead 314 is of the same type as bead 311, and bead 314 also has eight antibodies, and also at three of these antibodies proteins are attached. Thus the protein concentration of the specific protein which attaches to the specific antibody at the specific bead, will be measured by means of impedance to be the same, when measuring impedance for beads 311 and 314.

Beads 312 and 313 are a different type of bead than beads 311 and 314. Beads 312 and 313 are each shown to have fourteen antibodies attached. The antibodies at bead 312 and 313 are different than the antibodies at the beads 311 and 314, since different proteins should attach to different beads. Seven proteins and five proteins, respectively, are shown to be attached to the beads 312 and 313. Thus depending on the accuracy of the impedance measurement, beads 312 and 313 will not have the same impedance value, since the amount of protein attached at bead 312 is different from the amount of protein attached to bead 313. However, the difference in protein concentration as measured by means of bead 312 and 313 may be within the uncertainty of the measurement or within the natural variation of protein attachment to beads.

The amount of protein attached to different beads can be same, and even if the amount of proteins bound to different beads is same, the different impedance values will not overlap. As an example, beads 311 and 312 can both have eight antibodies attached, and they can have the same change in impedance due to proteins attachment, but their impedance values will not be same, or not be within the same ranges.

The dimensions in FIG. 3 are not drawn to scale.

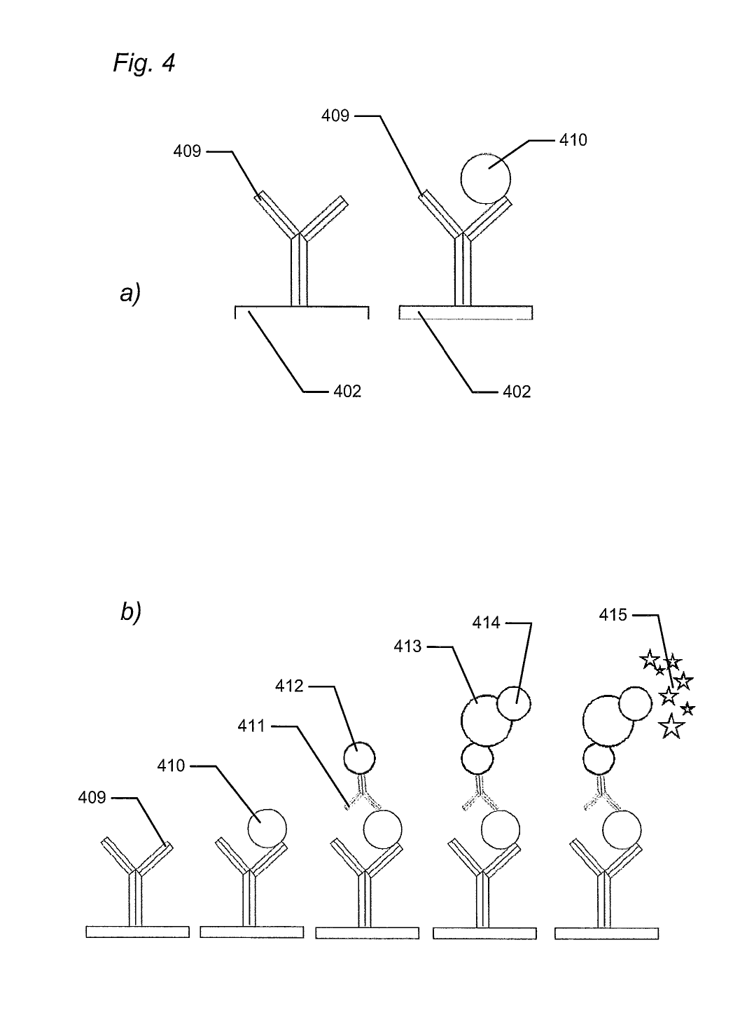

FIG. 4 shows the binding steps in the present method and in prior art method.

FIG. 4a) shows the two binding steps in the present method in order to determine the concentration of specific proteins, where the binding steps are: attachment of the antibody 409 or capture antibody to the surface of the bead 402, and attachment of protein 410 or target protein to the antibody 409. After the protein 410 is attached, the impedance of the bead with protein can be measured, and the concentration of the protein can be determined.

FIG. 4b) shows the five binding steps required in the prior art method of ELISA for measuring the protein concentration of a single protein type. The first two steps of the prior art method are similar to the present method, which is attachment of the antibody 409 or capture antibody to a surface, and attachment of protein 410 or target protein to the antibody 409. Then the third step comprises attachment of a detection antibody 411 with Streptavidin 412 to the target protein 410, the fourth step comprises attachment of Biotin 413 and HRP 414 to the detection antibody 411 and Streptavidin 412, and then finally the fifth step comprises excitation of the HRP 414 so that fluorescent light 415 is emitted, and from the fluorescence it can be determined what the concentration of the target protein is.

Thus in the present method, the analyte or target protein is not labelled, i.e. there is no detection antibody, and no excitation in order to emit fluorescent light etc.

The dimensions in FIG. 4 are not drawn to scale.

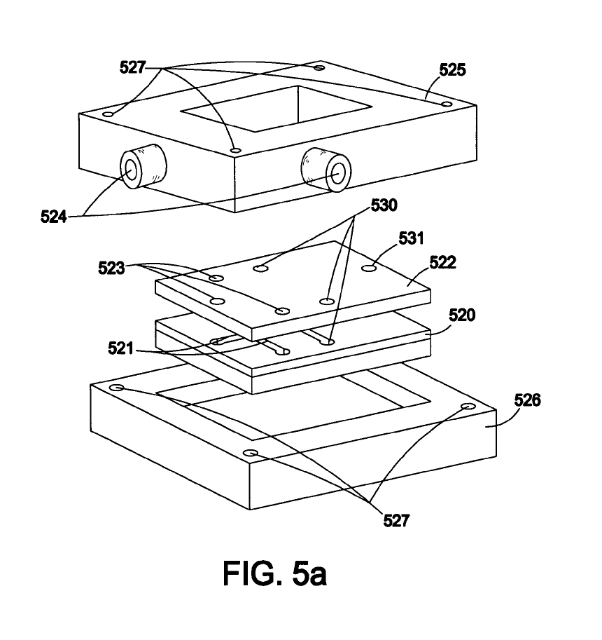

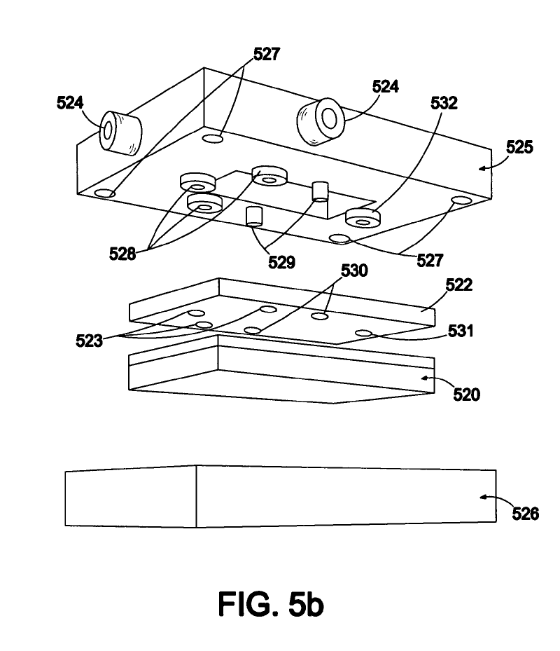

FIG. 5 shows an example of a micro fluidic chip in a casing to be used as a part of a device used for performing the present method.

FIG. 5a) shows the micro fluidic chip and casing in a perspective view seen from above and from the side.

FIG. 5b) shows the microfluidic chip in a perspective view seen from below and from the side.

The chip 520 comprises micro fluidic channels 521 in which beads and proteins flow to pass electrodes, whereby the impedance is measured, for example of beads with proteins attached, whereby the concentration of the proteins can be determined.

Above the chip 520 is a chip top lid 522, which has holes 523 for introducing fluidics into the micro fluidic channels.

The fluidic is initially introduced through the fluid inlet(s) 524 in the top lid 525 of the casing. The top lid 525 can be screwed into the bottom part 526 of the casing by means of screws into the screw holes 527, whereby the chip 520 and the chip lid 522 are fixedly secured inside the casing.

O-rings 528 are arranged at the holes 523 on the underside of the top lid 525 to ensure a tight sealing.

Electrical spring connections 529 are arranged on the underside of the top lid 525 and engage into holes 530 configured for receiving the electrical spring connections, where the holes 530 are arranged in the chip 520 and in the chip top lid 522. The electrical spring connections 529 provide the electrical connections with the electrodes (not shown) arranged in the chip 520.

Outlets 531 for discharging the fluidics is arranged in the chip 520 and in the chip top lid 522, and an O-ring 532 is arranged at the outlet 531 on the underside of the top lid 525 to ensure a tight sealing.

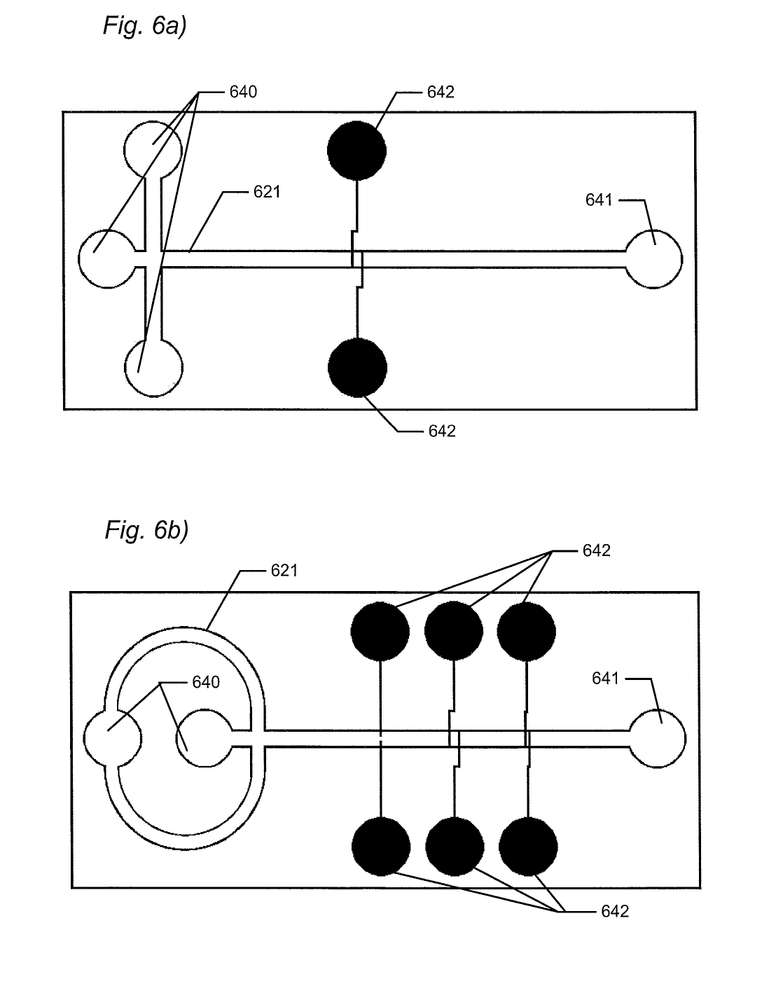

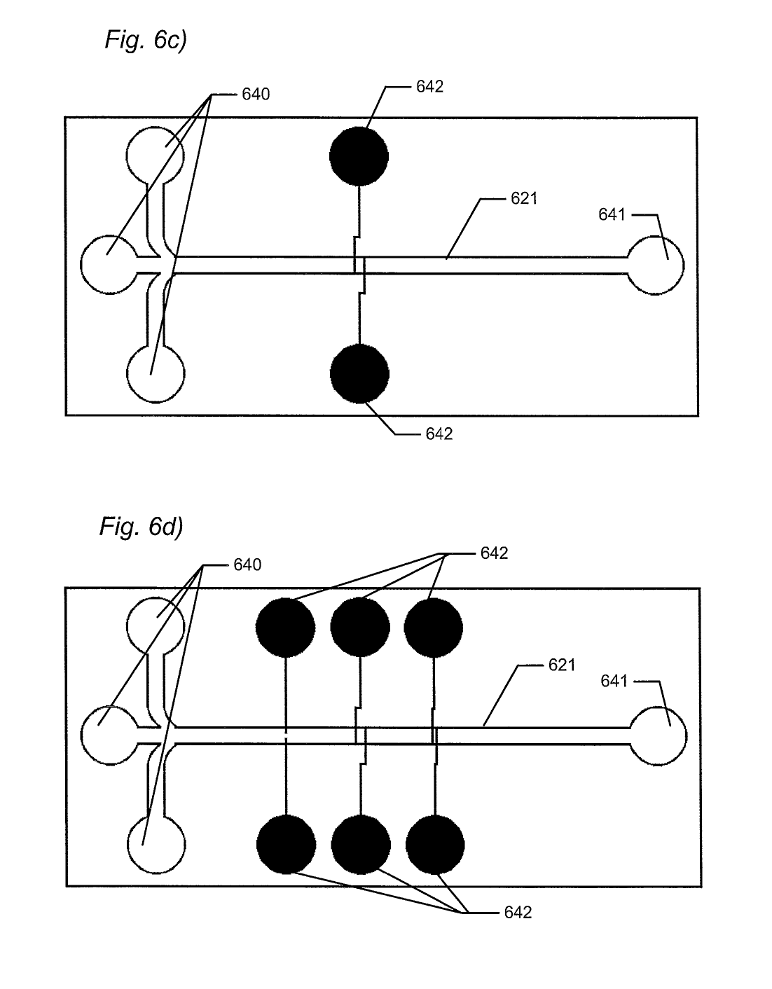

FIG. 6 shows examples of embodiments of the micro fluidic channels on the chip.

The micro fluidic channels 621 comprise inlet areas 640, where fluid is supplied, and an outlet area 641, where fluid is discharged after having passed through the channels 621. Particles, called beads in the following, may be supplied into one of the inlet areas, and a sample containing proteins, for example from or in a blood sample, may be supplied into another one of the inlet areas. When the separate channels from the bead inlet area and from the sample inlet area meet or merge into one single channel, the beads and the sample containing proteins are mixed and proteins from the sample may attach to the antibody molecules on the beads in a specific binding process, where protein XP binds specifically to antibody XA on bead XB, and where protein YP binds specifically to antibody YA on bead YB.

Alternatively, the mixing of the beads and proteins may be performed before applying the fluidics into the micro fluidic channels.

A number of electrodes 642 are also arranged at the micro fluidic channels for measuring for example the electrical impedance change when a bead passes the electrodes, whereby the concentration of proteins in the fluid can be determined, since the proteins have bound specifically to certain beads.

FIG. 6a) shows micro fluidic channels 621 with the same design as seen in FIG. 5. There are three inlet areas 640, two electrodes 642 and one outlet 641.

FIG. 6b) shows micro fluidic channels 621 with two inlet areas 640 arranged in a round, circular, annular or elliptical shape of channels. There are six electrodes 642, whereby the electrical measurement, for example impedance measurement, can be performed three times for each bead. Three measurements in total can be used to calculate a mean value, or to verify e.g. the first measurement etc.

FIG. 6c) shows micro fluidic channels 621 with three inlet areas 640, where the channels from two of the inlet areas have a curved shape at the point where they meet or merge with the channel from the third inlet area. Hereby potential turbulence, when the streams or flows from the three inlet areas 640 meet, converges, or confluences, may be reduced. Furthermore, there are two electrodes 642.

FIG. 6d) shows micro fluidic channels 621 with three inlet areas 640, where the channels from two of the inlet areas have a curved shape at the point where they meet or merge with the channel from the third inlet area, whereby potential turbulence at the confluence may be reduced. Furthermore, there are six electrodes 642.

FIG. 6e) shows micro fluidic channels 621 with three inlet areas 640, where the channels from two of the inlet areas have a curved shape at the point where they meet or merge with the channel from the third inlet area, whereby potential turbulence at the confluence may be reduced.

After the channels from the three inlet areas are merged into one channel, the channel has a curved or meandering shape, whereby the length of the channel is increased without increasing the length of the chip onto where the micro fluidic channels are arranged. The increased length of the joint channel or common channel allows for longer time for efficient mixing and binding event of the beads and the proteins. This is of particular relevance, if longer time for completion of binding events is needed.

Furthermore, there are six electrodes 642.

FIG. 6f) shows micro fluidic channels 621 with three inlet areas 640, where the channels from two of the inlet areas have a curved shape at the point where they meet or merge with the channel from the third inlet area, whereby potential turbulence at the confluence may be reduced.

After the channels from the three inlet areas are merged into one channel, the channel has a curved or meandering shape, whereby the length of the channel is increased without increasing the length of the chip onto where the micro fluidic channels are arranged. The increased length of the joint channel or common channel allows for longer time for efficient mixing and binding event of the beads and the proteins. This is of particular relevance, if longer time for completion of binding events is needed.

Several mixer-elements 643 are arranged along the curved or meandering shape of the joint channel or common channel for amplifying the mixing of the fluids comprising beads and proteins, respectively.

Furthermore, there are six electrodes 642.

It is understood that mixing-elements alternatively and/or additionally may be arranged at the straight portions of the joint or common channel as well, and that mixing-element also may be arranged in micro fluidic channels having no curved or meandering shape at all.

The dimensions in FIG. 6 are not drawn to scale.

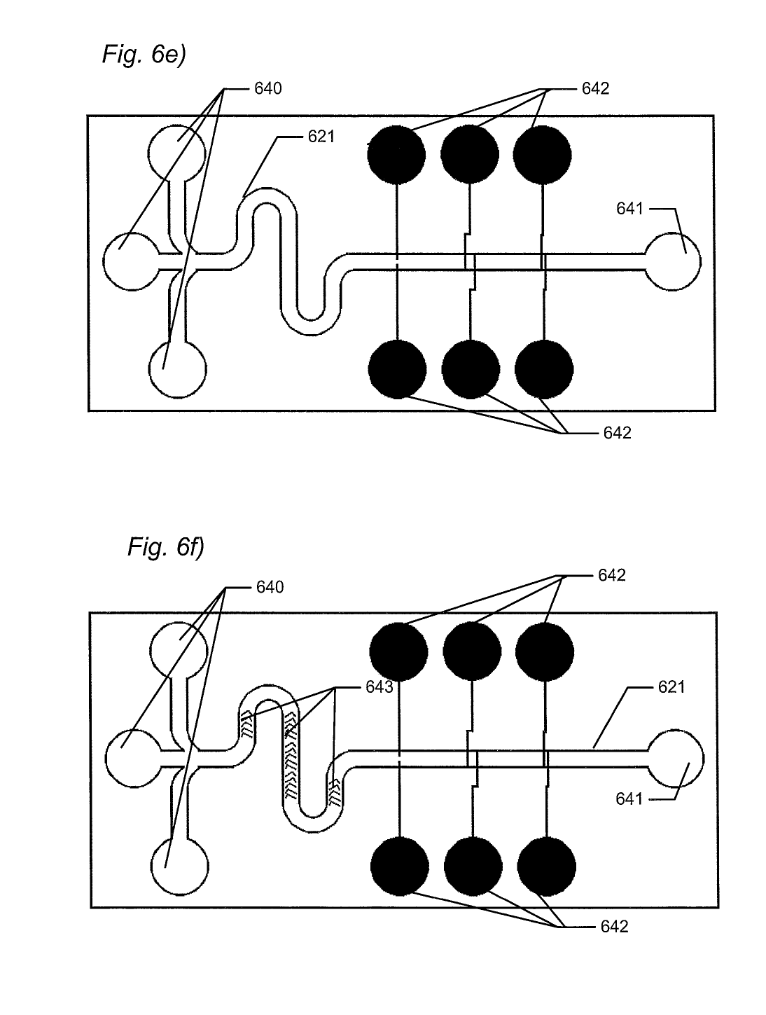

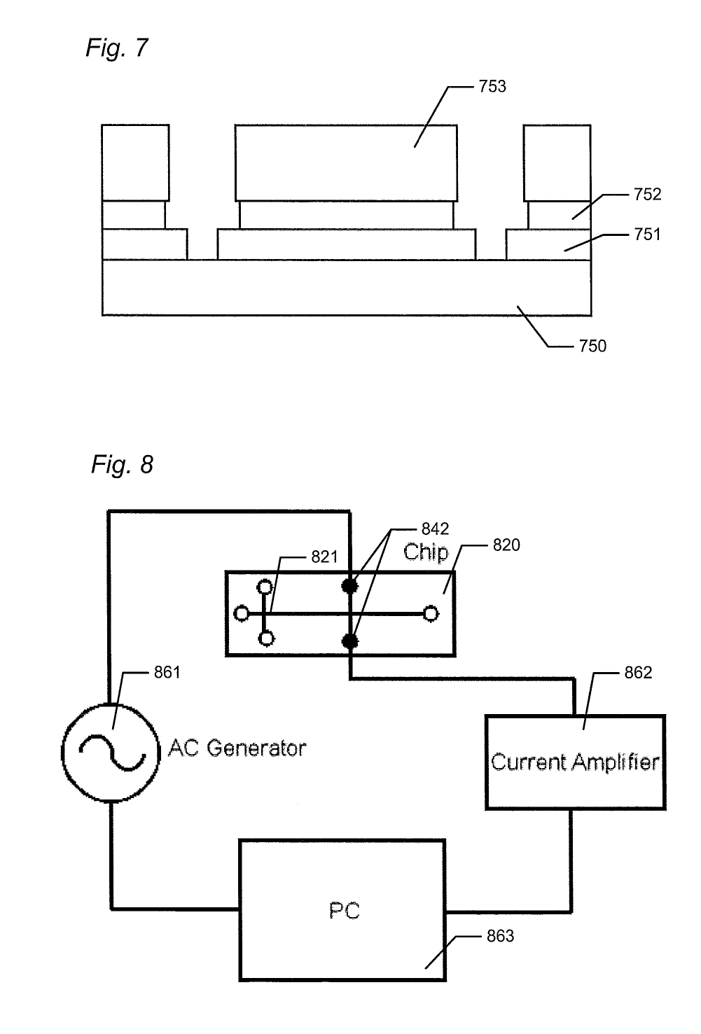

FIG. 7 shows an example of the composition or construction of the chip with micro fluidic channels.

The bottom or first layer 750 may be made of glass, Pyrex, Borofloat, Silicon covered with oxide, etc.

The second layer 751 may be made of polymer, such as SU-8, which is an epoxy-based negative photo-resistant polymer. The bottom and second layers may also be integrated in one material.

The third layer 752 may be made of polymer, such as Polydimethylsiloxane (PDMS), which is a polymeric organosilicon compound, which is commonly referred to as silicone.

The top or fourth layer 753 may be made of plastic, such as Poly(methyl methacrylate) (PMMA), which is a thermoplastic and transparent plastic, commonly called acrylic glass, simply acrylic, perspex or plexiglas.

The advantage of using a plastic, or a polymer, or a polymer-based material or co-polymer-based material is that it may sustain a stable structure in the micrometer or sub-micrometer range.

A further advantage is that by using a polymer material, the fabrication process is rendered simple, cheap, fast and flexible. It is an advantage that a cheap device may be provided, e.g. since a chip may be used to measure chemical and/or biological substance which may be difficult to, and/or time consuming to and/or even toxic to clean off a device, rendering it desirable to provide a single-use device.

FIG. 8 shows an example of the electric circuit used to perform the electrical impedance measurement.

An AC generator 861 is connected to the electrode(s) 842 in the chip 820, and the micro fluidic channels 821 in the chip are also shown. The electrodes 842 in the chip are also connected to an amplifier 862, and the amplifier is connected to a computer or PC 863. The PC is finally connected to the AC generator.

The PC may comprise an oscilloscope, a processor, memory etc.

The components are connected by means of electrical wires.

When the AC generator 861 generates AC voltage, a voltage difference is applied to the electrodes 842, whereby for example impedance or a change in impedance of the substances flowing past the electrodes in the micro fluidic channel can be measured. The impedance may be obtained by dividing the amplitude of the applied voltage with the amplitude of the measured current. The relative phase between the two signals may be used for measuring the protein concentration as this can depend on the concentration. The concentration of for example proteins in the substance can thereby be measured, and this can be used to perform a disease diagnosis for a patient.

When alternating current (AC) is used in the electrical system, the direction of flow of the electrons changes periodically, maybe many times per second.

Alternatively, DC voltage may be used instead of AC voltage, and then electrical conductance can be measured instead of electrical impedance.

The dimensions in FIG. 8 are not drawn to scale.

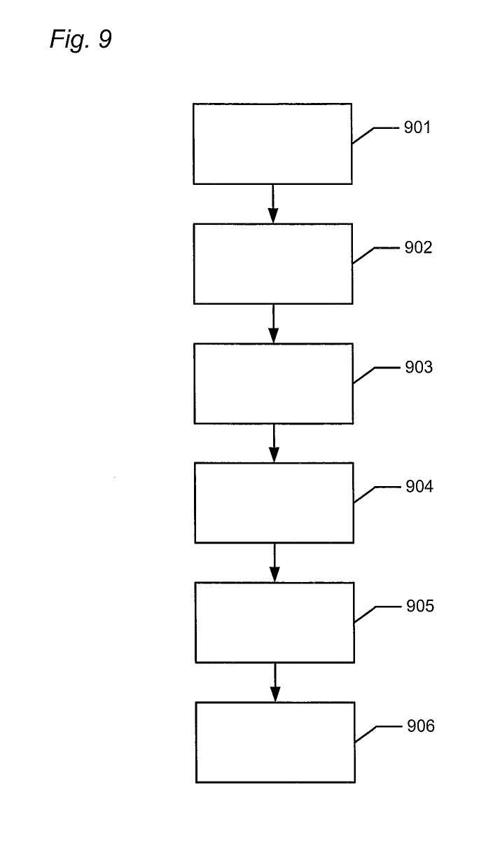

FIG. 9 shows an example of a flow diagram of the present method.

In step 901 a blood sample is provided from a patient in order to perform a disease diagnoses.

In step 902 a suitable amount of suitable beads with antibodies specific for certain proteins is provided. The antibodies are chosen so that it can be tested what the concentration of the certain proteins are, since it is presumed that the concentration of these certain proteins in the patient's blood are dependent for which disease the patient has.

In step 903 the blood sample and the beads with antibodies are mixed, so that the proteins in the patient's blood can attach to the antibodies specific for that protein.

In step 904 the beads, onto which certain proteins now have attached by specific binding with the antibodies, are passed to electrodes. An AC voltage difference is applied to the electrodes, whereby the electric impedance of each of the beads is measured. Thus the impedance measurement of one bead may be referred to as an event.

In step 905 the impedance measurements are analysed in an analyser unit. The analyser unit comprises a register in which data is stored which associates each possible impedance value with a concentration of a certain protein. Thus for each of the events, i.e. each of the impedance measurement, the analyser finds a protein concentration of a certain protein which corresponds to that impedance value.

In step 906 the different detected protein concentrations are displayed, or printed out or send to a receiver, whereby the diagnoses can be made.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method of multiplexed concentration measurement of a plurality of analytes in a sample by means of electrical impedance measurements, the method comprising:
providing the sample comprising the plurality of analytes;
providing a plurality of particle subsets, where the particles in each subset comprise a number of capture molecules specific for at least one of the analytes, and where the particles in each subset are distinguishable from the particles in the other subsets;
mixing the sample comprising the plurality of analytes with the one or more subsets of particles, whereby the plurality of analytes are enabled to bind to the respective capture molecules;
wherein the method further comprises the steps of:
measuring the electrical impedance between electrodes, when the particles pass one or more sets of electrodes;
determining the concentrations of the plurality of analytes by analyzing the electrical impedance associated with the particles passing by the electrodes, where the concentrations of the plurality of analytes are determined based on a change in a property of the respective particles.

2. The method of claim 1, wherein the change property of a particle is at least the thickness of the layer of the attached analytes on the particle.

3. The method of claim 1, wherein the change in the property of a particle is at least the weight of the attached analytes on the particle.

4. The method of claim 1, wherein the change in the property of a particle is at least the electrical charge of the attached analytes on the particle.

5. A method according to claim 1, wherein the particles are beads.

6. The method of claim 1, wherein the particles are adapted to exhibit magnetic properties.

7. The method of claim 1, wherein the analytes are proteins.

8. The method of claim 1, wherein the capture molecules comprise reactive layers.

9. The method of claim 1, wherein the capture molecules comprise antibodies.

10. A device for multiplexed concentration measurement of a plurality of analytes in a sample by means of electrical impedance measurements, the device comprising:
a chip with micro-fluidic channels, where the micro-fluidic channels comprise a first part of a channel adapted for mixing the sample comprising the plurality of analytes with one or more subsets of particles, where the particles in each subset comprises a number of capture molecules specific for at least one of the analytes, whereby the one or more analytes are enabled to bind to the respective capture molecules, and where the particles in each subset are distinguishable from the particles in the other subsets,
electrodes in a second part of the channel for performing the electrical measurements, when the particles pass the electrodes;
where the change in the electrical impedance measurement is calculated by a processor, when a particle passes the electrodes and, based on this, the concentrations of the plurality of analytes are determined by analyzing the electrical impedance measurement change associated with the particles passing by the electrodes, where the concentrations of the plurality of analytes are determined based on a change in a property of the respective particles.

11. The device of claim 10, wherein the channels are treated on the internal side to prevent that analyte adheres inside the channels.

12. The device of claim 10, wherein channels comprise focusing means.
